(19) United States
(12) Patent Application Publication
(10) Pub. No.: US 2010/0094622 A1
(43) Pub. Date: Apr. 15, 2010

(54) FEATURE NORMALIZATION FOR SPEECH AND AUDIO PROCESSING

(75) Inventors: Peter S. Cardillo, Atlanta, GA (US); Mark A. Clements, Lilburn, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/564,457

(22) Filed: Sep. 22, 2009

Related U.S. Application Data
(60) Provisional application No. 61/104,333, filed on Oct. 10, 2008.

(51) Int. Cl. G10L 19/14

(52) U.S. Cl. 704/224; 704/E19.001

(57) ABSTRACT

Systems, method, and apparatus for processing a speech utterance or audio record that includes receiving one or more feature vectors characterizing the speech utterance or audio record, each feature vector having a plurality of feature elements, each feature element being associated with a spectral representation of a characteristic of one of a plurality of sequential segments of the speech utterance or audio record; and processing the one or more feature vectors in a rank order filter to obtain one or more normalized feature vectors, each normalized feature vector having a plurality of normalized feature elements corresponding to the plurality of feature elements.

### CROSS-REFERENCE TO RELATED APPLICATIONS

This application claims the benefit of U.S. Provisional Application No. 61/104,333 filed Oct. 10, 2008, the contents of which are incorporated herein in its entirety.

### BACKGROUND

This specification relates to feature normalization for speech and audio processing, including, for example, automatic speech recognition.

Automatic speech recognition (ASR) systems include systems that translate spoken languages into linguistically-based output, such as word-based transcripts and detections of word-based queries. The performance of ASR systems can be affected by variations introduced by many sources, including, for example, speaker characteristics and accents, microphones characteristics, room acoustics, ambient noise, and background interference. The presence of such variations in speech signals can sometimes lead to acoustic mismatches and reduced accuracy.

Many approaches have been proposed to improve the recognition performance and environmental robustness of ASR systems. One approach, for example, uses cepstral mean subtraction, a channel normalization technique to compensate for signal distortions caused by the communication channel. More specifically, the means of each of a set of recognition feature vectors are calculated and subtracted from their respective vectors, thereby producing a normalized feature representation whose long-term average characteristics have been removed or suppressed. Other approaches may use linear filters, for example, a high-pass filter that only suppresses DC components, for feature normalization.

Although effective in reducing certain types of channel-based errors, some feature normalization approaches may still be sensitive to other sources of variability. For example, normal human speech typically includes intervals of silence. In the presence of long periods of silence between words or sentences, the mean values computed for subtraction can be biased. The use of linear filtering for feature normalization may also be susceptible to outliers.

### SUMMARY

In general, one aspect of the invention features a method for processing a speech utterance or audio record that includes receiving one or more feature vectors characterizing the speech utterance or audio record, each feature vector having a plurality of feature elements, each feature element being associated with a spectral representation of a characteristic of one of a plurality of sequential segments of the speech utterance or audio record; and processing the one or more feature vectors in a rank order filter to obtain one or more normalized feature vectors, each normalized feature vector having a plurality of normalized feature elements corresponding to the plurality of feature elements.

Embodiments of the invention may include one or more of the following features.

The rank order filter may include a median filter. The method of processing the one or more feature vectors may include sequentially selecting N consecutive feature elements in the feature vector, N being an integer; and determining an output of each selection of the N consecutive feature elements according to a rank order criterion. The method of determining the output of each selection may includes ranking the selected N consecutive feature elements by magnitude; and identifying a feature element that has the P^{th} largest magnitude among the magnitudes of the N feature elements, P being an integer between 1 and N. The method of determining the output of each selection may includes forming a window vector of a plurality of window elements based on the selected N consecutive feature elements and a weight vector W, the weight vector having a plurality of weight elements representing the number of repetitions of the corresponding feature element in the window vector; ranking the window elements by magnitude; and identifying a window element that has the P^{th} largest magnitude among the magnitudes of the window elements, P being an integer between 1 and N. The method may further include iteratively performing the step of determining the output of each selection to optimize at least one of the N, P and W. The method may further include computing the one or more normalized feature vectors by subtracting the outputs of each selection of the N consecutive feature elements from the corresponding feature vector.

In general, a second aspect of the invention features a system for feature normalization that includes an interface for receiving one or more feature vectors characterizing a speech utterance, each feature vector having a plurality of feature elements, each feature element being associated with a spectral representation of a characteristic of one of a plurality of sequential segments of the speech utterance; and a processor for applying a rank order filtering technique to process the one or more feature vectors to obtain one or more normalized feature vectors, each normalized feature vector having a plurality of normalized feature elements corresponding to the plurality of feature elements.

Embodiments of the invention may include one or more of the following features.

The processor may include a median filter.

### DESCRIPTION OF DRAWINGS

FIG. 1 is a block diagram of an automatic speech recognition system.

FIG. 2 is a flow chart of a procedure of automatic speech recognition.

FIG. 3 is a flow chart of a procedure of feature normalization using a median filter.

FIG. 4 is an illustration of a 5-point median filter.

FIG. 5 is an illustration of a 3-point weighted median filter.

### DESCRIPTION

### 1 Feature Normalization in Speech and Audio Recognition

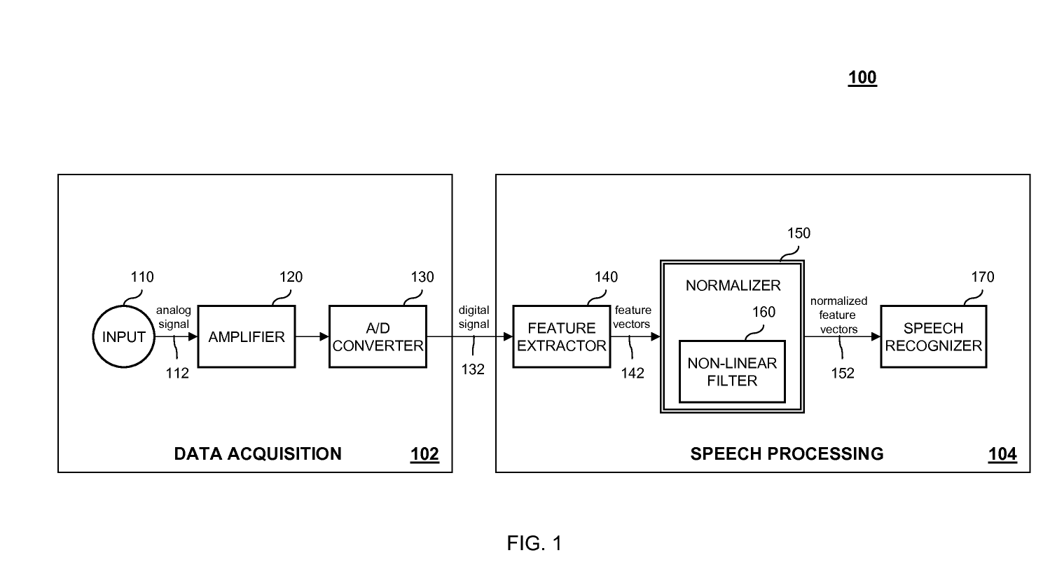

Referring to FIG. 1, an automatic speech recognition (ASR) system 100 includes a data acquisition system 102 for collecting speech signals (e.g., human voice) and a speech processing system 104 for translating the speech signals into machine-readable forms (e.g., text). Other systems in similar configuration to the ASR system 100 can also be used for recognition of non-speech audio events. For example, the speech processing system 104 may be an audio processing system for translating audio signals into machine-readable forms.

The acquisition system 102 includes an input device 110 (e.g., a microphone or a telephone) for receiving an analog speech signal 112 (e.g., in acoustic waveforms), an amplifier 120 for amplifying the analog signal 112, and an analog-to-digital (A/D) converter 130 for converting the amplified analog signal to a digital signal 132 to be processed by the speech processing system 104.

The speech processing system 104 includes a feature extractor 140 that extracts certain features of the digital signal 132 in the form of feature vectors 142, a normalizer 150 that normalizes the feature vectors 142 for enhancing the representation of desirable components in the feature vector, and a speech recognizer 170 that matches the normalized feature vectors 152 against a model of the desired outputs to generate output (e.g., a transcription or text of the speech or detections of user-specified queries). More specifically, the normalizer 150 includes a non-linear filter 160 that implements one or more non-linear filtering techniques to remove components introduced by the communication channel or other sources, which do not contribute to the ASR process. Such components are generically referred to as “noise” without any implication that they result from acoustic noise.

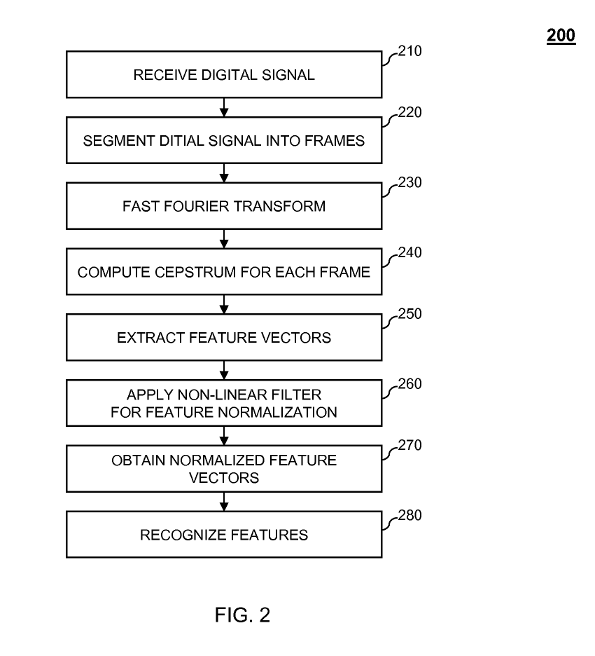

Referring to FIG. 2, a flow chart 200 illustrates an exemplary procedure of the speech processing system 104. In step 210, the stream of the digitized speech signal 132 is delivered to the feature extractor 140, which first segments the stream by evenly-space time intervals (“frames”). Each frame, for example, contains 20-millisecond of speech data and is spaced at 10-millisecond intervals. Prior to spectral analysis, each frame may be pre-processed by a suitable window function, for example, a Hamming or Hanning window. Optionally, the window may also be appended with additional zeros to extend data record.

Next, in step 230, each pre-processed signal frame is subjected to a Fast Fourier Transform algorithm to convert the time-domain signals to a power spectrum representation in the frequency domain. Subsequently, in step 240, a cepstrum is computed for each frame. Here, cepstrum refers to the inverse Fourier Transform of the logarithm of the power spectrum of a signal. Note that a property of cepstrum is that the convolution of two signals in the time domain corresponds to the addition of their cepstra in the cepstrum domain. Optionally, the power spectrum is warped along the frequency axis according to a mel scale before taking the inverse Fourier Transform of the logarithm spectrum to produce mel-frequency cap coefficients.

Assuming the communication channel is a linear time invariant (LTI) system, the speech signal 132 can be represented as the convolution of the input and the impulse response of the LTI system. Therefore, to characterize the speech signal in terms of the parameters of such a model, de-convolution is used. Cepstral analysis is an effective procedure for de-convolution, because the characteristics of the input signal and the channel appear as additive components in the cepstrum. The separation of such additive components in the cepstrum domain is thus useful in pitch extraction and formant tracking.

In step 250, every time a cepstrum is computed, a set of cepstral coefficients (cep [0], cep [1], cep [2], and etc.) or mel-frequency cepstral coefficients are obtained. The feature vectors 142 are then formed based on the cepstral coefficients. Depending on implementation, the feature vectors 142 encode information about certain features of the speech utterances from which patterns of words or sentences can be recognized. One example of a feature vector (e.g., feature [0]) is a time trajectory of its corresponding cepstral coefficient (e.g., cep [0]) produced at each successive frame in a given time interval. For instance, during an interval of 10 second and with a frame spacing of 10 millisecond, the vector of feature [0] includes 1000 data points of cep [0] obtained through 1000 frames in succession. Each feature vector may include noise components resulted from, for example, changes in the distance and position of a speaker's mouth from the microphone, background noise, and room acoustics.

To reduce noise impact, in step 260, a non-linear filter 160 is applied to the feature vectors 142 to produce normalized feature vectors 152. Depending on implementation, the non-linear filter 160 can be selected from a wide range of non-linear filters that are representable in the form of scale-space transformation, including, for example, median filters and rank order filters, as will be described in greater detail below. Compared with some traditional linear filtering techniques (e.g., low pass or high pass filters), the feature vectors normalized by the non-linear filtering techniques described herein can be less sensitive to the presence of intervals of silence in the original speech signal and be more robust to outliers (i.e., atypical extreme values), which could adversely impact a linear processing of the feature vector. These normalized feature vectors 152 are then processed in the speech recognizer 170, which, in step 280, performs recognition functionalities (e.g., probability estimation and classification) to reconstruct the spoken words in the input signal 112.

In the following sections, several examples of non-linear filters suitable for use are described in greater detail.

### 2 Example I

### N-Point Median Filter

A first example of the non-linear filter 160 is a median filter, which sequentially centers an N-point sampling window on each data point of an array and outputs the median values of the N data points sampled by each window.

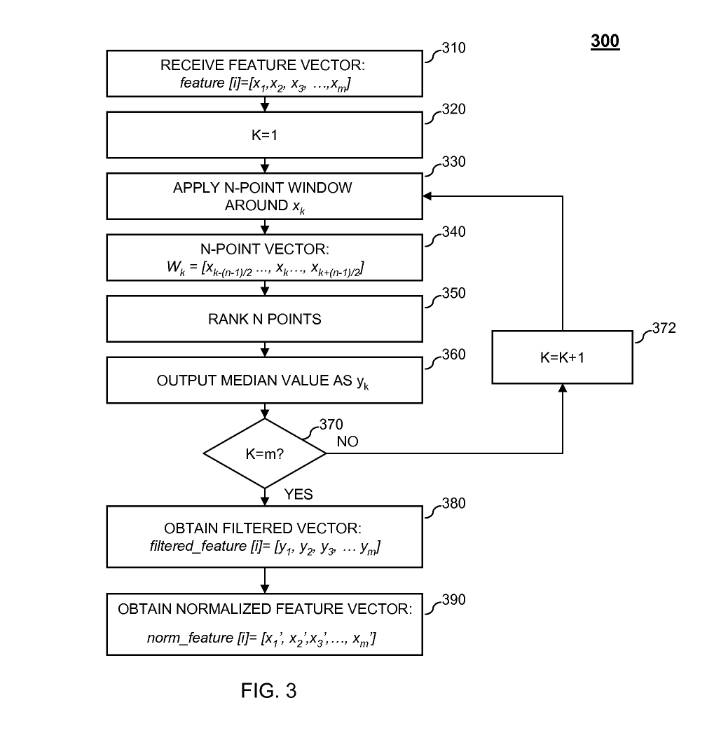

Referring to FIG. 3, a flow chart 300 illustrates an exemplary procedure of applying an N-point median filter to a feature vector, feature [i]. Here, N represents the size of the window and is typically selected to be an odd number. The vector of feature [i] corresponds to an array of cepstral coefficient cep [i] computed at successive frames. For purposes of illustration, feature [i] is represented as [x₁, x₂, x₃, . . . , xₘ], where x refers to the cepstral coefficient cep [i], and the subscript of m refers to the frame number.

In step 310, feature [i] is received. Starting from K=1, an N-point window vector wₖ is extracted to be consisting of the data points enclosed by the N-point window centered at the K^{th} element of feature [i]. Thus, wₖ can be represented as [x_{k-(N-1)/2}, . . . , xₖ, . . . , x_{k+(N-1)2}], in step 340.

Next, in step 350, the N elements of the window vector wₖ are ranked in ascending/descending order based on the magnitude. Subsequently, in step 360, the element having the median magnitude of the N elements is selected to be the median filtered output yₖ corresponding to input xₖ. For each iteration of K value (K no larger than the length of feature [i]), steps 330 through 370 are repeated to form a median filtered vector filtered_feature [i] that contains elements y₁, y₂, y₃, . . . , yₘ each being the respective filtered output of x₁, x₂, x₃, . . . xₘ. In some examples, this median filtered feature vector is output as the normalized feature vector norm_feature [i]. In some other examples, this median filtered feature vector is subtracted from the original feature vector feature [i] to obtain the normalized vector norm_feature [i].

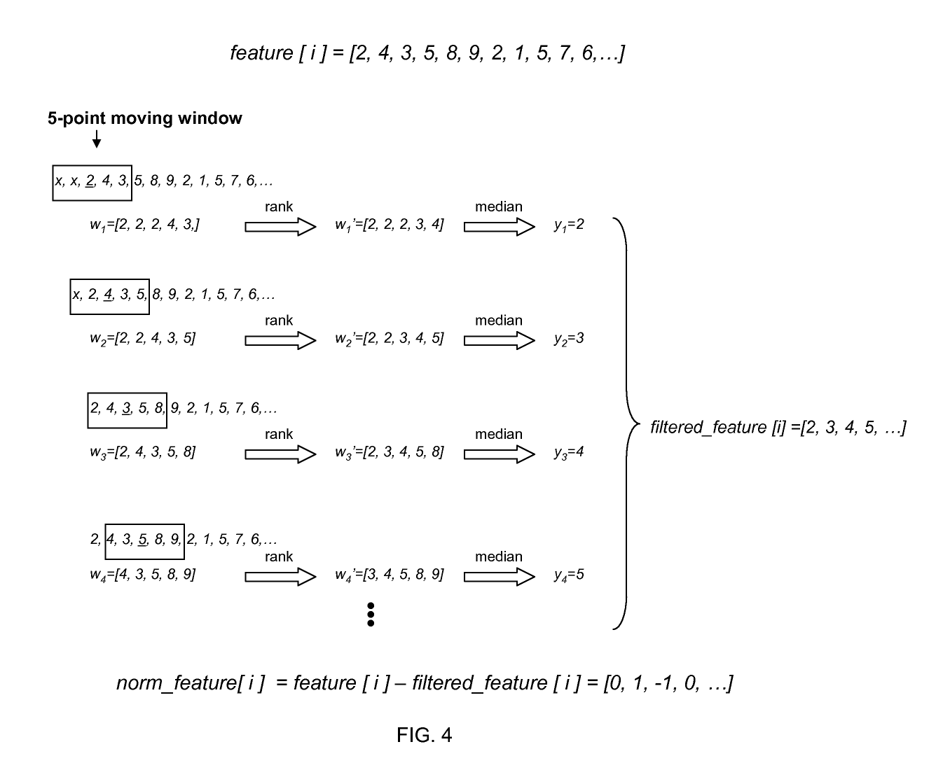

Referring to FIG. 4, for further illustration, a 5-point median filter is shown in use with a feature vector feature [i]=[2, 4, 3, 5, 8, 9, 2, 1, 5, 7, 6, . . . ]. For each window positioned around xₖ, five data points xₖ₋₂, xₖ₋₁, xₖ, xₖ₊₁, xₖ₊₂ are sampled and subsequently ranked. In some examples, when the window is centered on the edge (e.g., the first or second element), the resulting window vector (e.g., w₁ or W₂) is supplemented to a full 5-point length by edge repetition. Thus, w₁ is [2, 2, 2, 4, 3] and w₂ is [2, 2, 4, 3, 5]. After ranking, the window vectors w′₁ and w′₂ become [2, 2, 2, 3, 4] and [2, 2, 3, 4, 5], respectively. The median magnitude of each vector is then collected, yielding, for example, y₁=2 for w₁ and y₂=3 for w₂. As the sampling window proceeds, the filtered output filtered_feature [i] as being composed of y₁, y₂, . . . , yₘ is computed as [2, 3, 4, 5, . . . ].

In this example, the normalized feature vector norm_feature [i] is obtained by subtraction of the filtered vector from the original feature vector, so that a short-term “median” is suppressed. Hence, norm_feature [i] is equal to [0, 1, −1, 0, . . . ] as shown in the figure. In some other examples, a weighted filtered vector (e.g., filtered_feature [i] multiplied by a scalar factor S) may be subtracted from the original feature vector to produce the normalized feature vector. In other examples, the filtered_feature [i] (or alternatively, a weighted filtered_feature [i]) may be directly output as the norm feature [i], i.e., [2, 3, 4, 5, . . . ].

### 3 Example II

### N-point Weighted Median Filter

A second example of the non-linear filter 160 is an N-point weighted median filter that applies a sampling window similar to the one described in FIG. 3 but with different weights to each sampled data points.

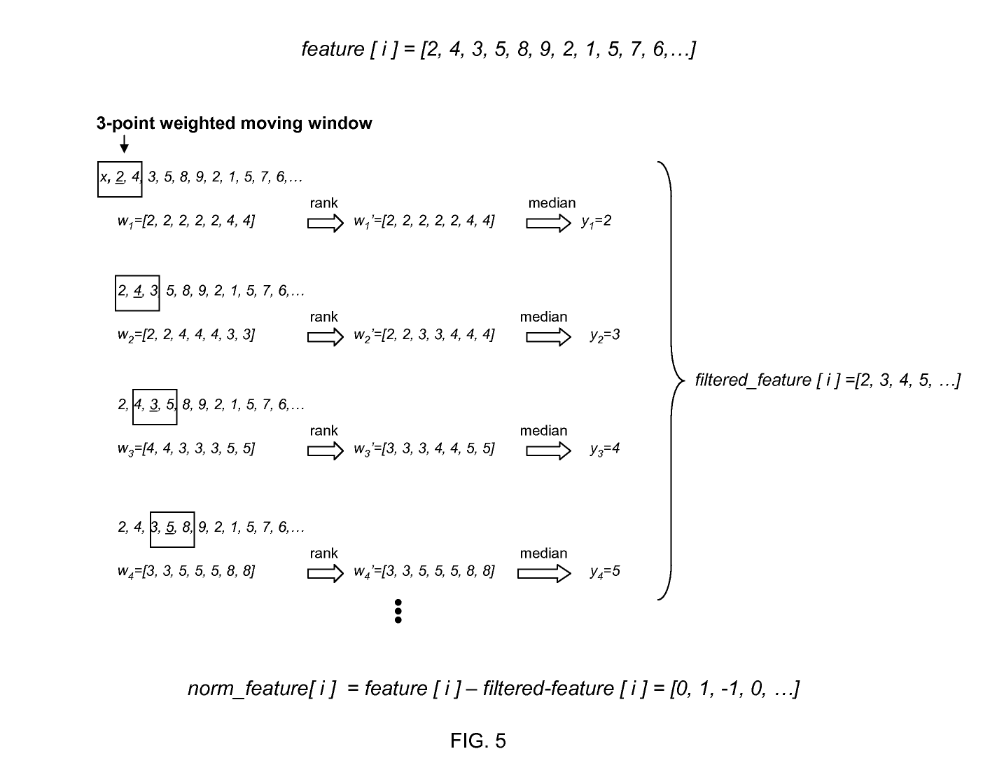

Referring to FIG. 5, an exemplary 3-point weighted medial filter is applied to the same feature vector feature [i]=[2, 4, 3, 5, 8, 9, 2, 1, 5, 7, 6, . . . ]. In this example, three data points xₖ₋₁, xₖ, xₖ₊₁ are sampled at a time. A weight of 3 is assigned to xₖ, and a weight of 2 is assigned to each of xₖ₋₁ and xₖ₊₁. Thus, a window vector wₖ is obtained as [xₖ₋₁, xₖ₋₁, xₖ, xₖ, xₖ, xₖ₊₁, xₖ₊₁]. These seven elements are then sorted based on their respective values, the median of which is output as yₖ. As a result, the filtered feature vector of this example filtered_feature [i] is [2, 3, 4, 5, . . . ].

### 4 Example III

### N-Point Rank Order Filter

A third example of the non-linear filter 160 is an N-point (and optionally, weighted) rank-order filter with an adjustable rank parameter P, such that the output of each window vector is its P^{th} largest element (which may be specified as a percentile, with a median corresponding to a 50^{th} percentile).

Referring again to FIG. 3, the procedure of the rank order filter is similar to the one described in flow chart 300 with the exception that, in step 360, the P^{th} largest data point (rather than the median) is now selected to be yₖ. Note that, when P is equal to (N+1)/2, the rank order filter is effectively a median filter. Therefore, the median filters described above can also be considered as a subgroup of rank order filters.

In many situations, the length N of the sampling window, the rank parameter P, the respective weights assigned to the sampled elements, and the scalar factor S applied to the filtered vector may all have an influence on the performance of the non-linear filtering, including, for example, affecting the type and the amount of noise component that is removed. In some applications, the selection of parameters can be optimized by taking into account various design and impact factors. For example, the characteristics of the most prominent or undesired component(s) of the channel noise may be pre-analyzed to provide guidance to filter design. Filters of different parameters may also be pre-tested on a representative set of training data to select the one(s) that yield the most truthful recognition outcome to the original data.

In addition to automatic speech recognition, the feature vector normalization approaches described above are useful in many speech-related applications, including, for example, audio signal classification, audio event detection, voice identification, pitch detection, and other classification and detections that reply on microphone input.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A method for processing a speech utterance or audio record comprising:
receiving one or more feature vectors characterizing the speech utterance or audio record, each feature vector having a plurality of feature elements, each feature element being associated with a spectral representation of a characteristic of one of a plurality of sequential segments of the speech utterance or audio record; and
processing the one or more feature vectors in a rank order filter to obtain one or more normalized feature vectors, each normalized feature vector having a plurality of normalized feature elements corresponding to the plurality of feature elements.

2. The method of claim 1, wherein the rank order filter includes a median filter.

3. The method of claim 1, wherein processing the one or more feature vectors includes:
sequentially selecting N consecutive feature elements in the feature vector, N being an integer; and
determining an output of each selection of the N consecutive feature elements according to a rank order criterion.

4. The method of claim 3, wherein determining the output of each selection includes:
ranking the selected N consecutive feature elements by magnitude; and
identifying a feature element that has the P^{th} largest magnitude among the magnitudes of the N feature elements, P being an integer between 1 and N.

5. The method of claim 3, wherein determining the output of each selection includes:
forming a window vector of a plurality of window elements based on the selected N consecutive feature elements and a weight vector W, the weight vector having a plurality of weight elements representing the number of repetitions of the corresponding feature element in the window vector;
ranking the window elements by magnitude; and
identifying a window element that has the P^{th} largest magnitude among the magnitudes of the window elements, P being an integer between 1 and N.

6. The method of claim 5, further comprising:
iteratively performing the step of determining the output of each selection to optimize at least one of the N, P and W.

7. The method of claim 3, further comprising:
computing the one or more normalized feature vectors by subtracting the outputs of each selection of the N consecutive feature elements from the corresponding feature vector.

8. A system for feature normalization comprising:
an interface for receiving one or more feature vectors characterizing a speech utterance, each feature vector having a plurality of feature elements, each feature element being associated with a spectral representation of a characteristic of one of a plurality of sequential segments of the speech utterance; and
a processor for applying a rank order filtering technique to process the one or more feature vectors to obtain one or more normalized feature vectors, each normalized feature vector having a plurality of normalized feature elements corresponding to the plurality of feature elements.

9. The system of claim 8, wherein the processor includes a median filter.
